(19) United States
(12) Patent Application Publication
(10) Pub. No.: US 2026/0247319 A1
(43) Pub. Date: Aug. 20, 2026

(54) METHOD AND SYSTEM FOR DUAL REGISTRATION AND TRANSMISSION CONTROL IN WIRELESS COMMUNICATION NETWORK

(71) Applicant: Samsung Electronics Co., Ltd., Suwon-si (KR)

(72) Inventors: Lalith KUMAR, Bangalore (IN); Vishal YADAV, Bangalore (IN); Danish Ehsan HASHMI, Bangalore (IN); Jagadeesh GANDIKOTA, Bangalore (IN)

(21) Appl. No.: 19/644,276

(22) Filed: Apr. 10, 2026

Related U.S. Application Data
(63) Continuation of application No. PCT/KR2024/021134, filed on Dec. 26, 2024.

(30) Foreign Application Priority Data
Dec. 29, 2023 (IN) 202341089941
Dec. 13, 2024 (IN) 202341089941

(51) Int. Cl. H04W 60/00; H04W 48/16; H04W 48/18; H04W 84/04

(52) U.S. Cl. CPC H04W 60/005; H04W 48/16; H04W 48/18; H04W 84/042

(57) ABSTRACT

A method and system for dual registration and transmission in a wireless communication network, wherein the UE registers on a first access network is disclosed. The UE receives a dual steering policy from network apparatus while registered on the first access network. The dual steering policy are used for selection of a second access network for the dual registration and transmission control. Further the UE selects the second access network for the dual registration and transmission control based on the dual steering policy.

### CROSS-REFERENCE TO RELATED APPLICATIONS

This application is a continuation of International Application No. PCT/KR2024/021134 designating the United States, filed on December 26, 2024, in the Korean Ministry of Intellectual Property Receiving Office and claiming priority to Indian Provisional Patent Application No. 202341089941, filed on December 29, 2023, and Indian Complete Patent Application No. 202341089941, filed on December 13, 2024, in the Indian Patent Office, the disclosures of each of which are incorporated by reference herein in their entireties.

### BACKGROUND

### FIELD

[1] The disclosure relates to wireless communication, and particularly relates to method and system for dual registration and transmission control in a wireless communication network.

### DESCRIPTION OF RELATED ART

[2] In the realm of wireless communications, dual steering has emerged as a significant technological advancement aimed at enhancing signal strength, reducing interference, and increasing the capacity and reliability of communication systems. Dual steering involves the use of adaptive beamforming or antenna steering technologies to direct wireless signals more precisely toward specific devices or areas, rather than broadcasting them omnidirectionally. This capability allows for the simultaneous or adaptive steering of multiple beams, thereby improving the quality and strength of the signal received by end-users.

[3] Despite its potential benefits, dual steering presents several challenges and limitations that affect its practical implementation and performance. One of the primary challenges is the reliance on accurate channel estimation. For dual steering to effectively direct beams toward intended users or devices, the network or device must accurately estimate the channel conditions. However, this may be problematic in scenarios involving rapid mobility, changing environmental factors, or poor signal quality. In such cases, the dual-steering system may fail to deliver optimal performance, leading to weaker signals, increased interference, or reduced throughput.

[4] Additionally, dual steering devices, which support traffic steering and switching of user data across two 3GPP access networks, face complexities in managing data transmission. These devices may either be a single user equipment (UE) handling non-simultaneous data transmission over the two networks or two separate UEs managing simultaneous data transmission. Traffic steering involves selecting an access network and transferring traffic over the chosen network, which may apply to traffic of one or multiple services/applications. This process becomes particularly challenging when different services are steered across different networks concurrently, requiring precise coordination to maintain service quality.

[5] Traffic switching, another critical procedure, involves moving all traffic from one access network to another with minimal service interruption. This is essential for maintaining seamless connectivity, especially in scenarios where services use the same network connection at a time or are distributed across different networks. The lack of a systematic method for configuring policies at the UE to facilitate dual steering further complicates the situation, as current systems do not provide adequate provisions for such configurations.

[6] The aforementioned challenges highlight the need for improved methodologies and systems to enhance the performance and reliability of dual steering in wireless communication networks. Addressing these issues is crucial for realizing the full potential of dual steering technologies and ensuring robust communication experiences for users.

[7] Thus, it is desired to address the above-mentioned disadvantages, issues or other shortcomings or at least provide a useful alternative.

### SUMMARY

[8] Embodiments of the disclosure provide a system and method for dual registration and transmission control in a wireless communication network.

[9] Embodiments of the disclosure provide dual steering policy and data transmission rules for the selection of the second access network.

Embodiments of the disclosure provide a home public land mobile network (HPLMN) that decides the policies which the UE should follow to perform the PLMN selection for dual registration purpose. The policies are provided to the UE in a non-access stratum (NAS) message when UE registers on the first access network.

Embodiments of the disclosure provide the HPLMN that may control if the UE may perform simultaneous transmission or not perform simultaneous transmission. The HPLMN provides this policy to the UE, the UE based on this instruction from the HPLMN the UE will decide whether to perform simultaneous transmission or non-simultaneous transmission for the flow of the data.

According to an example embodiment, a method for dual registration and transmission control in a wireless communication network is disclosed. The method includes registering by the UE on a first access network. The UE receives a dual steering policy from a network apparatus while registered on the first access network. The dual steering policy is used for the selection of a second access network for the dual registration and transmission control. Further, the UE selects the second access network for the dual registration and transmission based on the dual steering policy. The dual steering policy contains at least one of a prioritized list of public land mobile network identifier (PLMN-ID) on which the UE is permitted to register on the second access network, a prioritized list of access network types, a prioritized list of radio access technologies (RATs) on which the UE is permitted to register on the second access network, an area in which the UE is permitted to register on the second access network, or time information during which the UE is permitted to register on the second access network.

According to an example embodiment, a method for dual registration and transmission is disclosed. The method includes generating by the network apparatus a dual steering policy for a user equipment (UE). Further, the network apparatus transmits the dual steering policy to the UE for the selection of a second access network for the dual registration and transmission control. The dual steering policy contains at least one of a prioritized list of public land mobile network identifier (PLMN-ID) on which the UE is permitted to register on the second access network, a prioritized list of access network types, a prioritized list of radio access technologies (RATs) on which the UE is permitted to register on the second access network, an area in which the UE is permitted to register on the second access network, or time information during which the UE is permitted to register on the second access network.

According to an example embodiment, a network apparatus for dual registration and transmission control in a wireless communication network is disclosed. The network apparatus includes at least one processor comprising processing circuitry and memory storing instructions. The instructions, when executed by at least one processor, individually and/or collectively, cause the network apparatus to: generate a dual steering policy for the UE; and transmit the dual steering policy to the UE for the selection of a second access network for the dual registration and transmission control, wherein the dual steering policy contains at least one of a prioritized list of public land mobile network identifier (PLMN-ID) on which the UE is permitted to register on the second access network, a prioritized list of access network types, a prioritized list of radio access technologies (RATs) on which the UE is permitted to register on the second access network, an area in which the UE is permitted to register on the second access network, and/or time information during which the UE is permitted to register on the second access network.

According to an example embodiment, a user equipment (UE) for dual registration and transmission control in a wireless communication network is disclosed. The UE includes: at least one processor comprising processing circuitry and memory storing instructions. The instructions, when executed by at least one processor, individually and/or collectively, cause the UE to: register on the first access network; receive a dual steering policy from the network apparatus while registering on the first access network, wherein the dual steering policy is configured for the selection of a second PLMN for the dual registration and transmission control; and select the second access network for the dual registration and transmission control based on the dual steering policy, wherein the dual steering policy contains at least one of a prioritized list of public land mobile network identifier (PLMN-ID) on which the UE is permitted to register on the second access network, a prioritized list of access network types, a prioritized list of radio access technologies (RATs) on which the UE is permitted to register on the second access network, an area in which the UE is permitted to register on the second access network, and/or time information during which the UE is permitted to register on the second access network.

These and other aspects of the disclosure will be better appreciated and understood when considered in conjunction with the following description and the accompanying drawings. It is understood, however, that the following descriptions, while indicating various example embodiments and numerous specific details thereof, are given by way of illustration and not of limitation. Many changes and modifications may be made within the scope of the disclosure without departing from the spirit thereof, and the embodiments herein include all such modifications.

### BRIEF DESCRIPTION OF THE DRAWINGS

These and other features, aspects, and advantages of certain embodiments of the present disclosure will be more apparent from the following detailed description, taken in conjunction with the accompanying drawings, throughout which like reference letters indicate corresponding parts in the various figures, in which:

FIG. 1 is a signal flow diagram illustrating a scenario of the UE requesting traffic steering and switching of the user data according to the prior art.

FIG. 2 is a block diagram illustrating an example configuration of the network apparatus according to various example embodiments.

FIG. 3 is a block diagram illustrating an example configuration of the UE according to various example embodiments.

FIG. 4 is a signal flow diagram illustrating example operations of the UE with active dual steer functionality according to various example embodiments.

FIG. 5 is a flowchart illustrating an example method of dual registration and transmission control in a wireless communication network according to various example embodiments.

FIG. 6 is a flowchart illustrating an example method of dual registration and transmission control in a wireless communication network according to various example embodiments.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show various details that are pertinent to the understanding the various example embodiments of the disclosure so as not to obscure the drawing with details that will be readily apparent to those of ordinary skill in the art having benefit of the description herein.

### DETAILED DESCRIPTION

The various example embodiments herein and the various features and details thereof are explained more fully with reference to the non-limiting example embodiments that are illustrated in the accompanying drawings and in the following description. Descriptions of well-known components and processing techniques may be omitted so as to not unnecessarily obscure the example embodiments herein. The various example embodiments described herein are not necessarily mutually exclusive, as various embodiments can be combined with one or more embodiments to form new embodiments. The term "or" as used herein, refers to a non-exclusive or, unless otherwise indicated. The examples used herein are intended merely to facilitate an understanding of ways in which the various embodiments herein can be practiced and to further enable those skilled in the art to practice the various example embodiments herein. Accordingly, the examples are not be construed as limiting the scope of the disclosure.

Various example embodiments are described and illustrated in terms of blocks that carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits of a block be implemented by dedicated hardware, or by a processor (e.g., one or more programmed microprocessors and associated circuitry), or by a combination of dedicated hardware to perform some functions of the block and a processor to perform other functions of the block. Each block of the various example embodiments be physically separated into two or more interacting and discrete blocks without departing from the scope of the disclosed method. The blocks of the various example embodiments be physically combined into more complex blocks without departing from the scope of the disclosed method.

The accompanying drawings are used to help easily understand various technical features and it is understood that the various example embodiments presented herein are not limited by the accompanying drawings. As such, the disclosed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Subject to HPLMN policy and network control, the 5G system are able to support mechanisms to enable traffic steering and/or switching of the dual steer device's user data (for different services) across two 3GPP access networks belonging to two PLMNs, assuming a business/roaming agreement between PLMN operators (if different), data anchoring in the HPLMN, and non-simultaneous transmission over the two networks. For traffic steering and/or switching of user data across two 3GPP access networks, the 5G system shall be able to allow an HPLMN to provide policies and criteria for the dual steer device to connect to an additional PLMN/NPN or an additional RAT within the same PLMN. The above requirements assume configuration of traffic policies under HPLMN control or negotiated between the HPLMN and other network operators considering, e.g., user subscription, application/traffic type, service preference, QoS requirements, location, time, UE capabilities, mobility, and connectivity conditions.

Target scenarios cover two 3GPP access networks belonging to the same PLMN or between two different PLMNs or between one PLMN and one PLMN-integrated NPN over the same or different RAT, which may use terrestrial and/or satellite access (including the case of two different satellite orbits). Scenarios may also include traffic steering and/or switching across LTE/EPC and NR/5GC with anchoring in 5GC.

In an example embodiment, the list of NAS messages include, but not limited to, REGISTRATION REQUEST message, DEREGISTRATION REQUEST message, SERVICE REQUEST message, CONTROL PLANE SERVICE REQUEST, IDENTITY REQUEST, AUTHENTICATION REQUEST, AUTHENTICATION RESULT, AUTHENTICATION REJECT, REGISTRATION REJECT, REGISTRATION ACCEPT, DEREGISTRATION ACCEPT, SERVICE REJECT, SERVICE ACCEPT, UE CONFIGURATION UPDATE command, and UE PARAMETERS UPDATE command.

The term RAT, as defined in the disclosure, may, for example, and without limitation, be one of the following: next generation radio access network (NG-RAN), 5G, 4G, 3G, 2G, evolved packet system (EPS), 5G system (5GS), new radio (NR), NR in unlicensed bands, new radio low earth orbit (NR LEO) satellite access, new radio medium earth orbit (NR MEO) satellite access, new radio geostationary earth orbit (NRGEO) satellite access, new radio other satellite (NROTHERSAT) satellite access, new radio reduced capability (NR RedCap), evolved universal terrestrial radio access (E-UTRA), E-UTRA in unlicensed bands, narrowband internet of things (NB-IoT), wideband internet of things (WB-IoT), and long-term evolution for machines (LTE-M).

In the context of the dual steer concept, the current standard does not have any provision that describes the method of configuring policy from the HPLMN/visited public land mobile network (VPLMN) to facilitate dual steering in the UE. Hence, it is desired to define policies at HPLMN, which include rules and criteria for selecting a second access network to facilitate traffic steering and switching of user data (for different services) across two 3GPP access networks. The method and system provide the dual steering policy and the data transmission rules for the selection of the second access network and to facilitate the data transmission over the second access network while being registered on the first access network.

Throughout the disclosure, the terms first PLMN and the first access network are used interchangeably. The second PLMN and the second access network are used interchangeably.

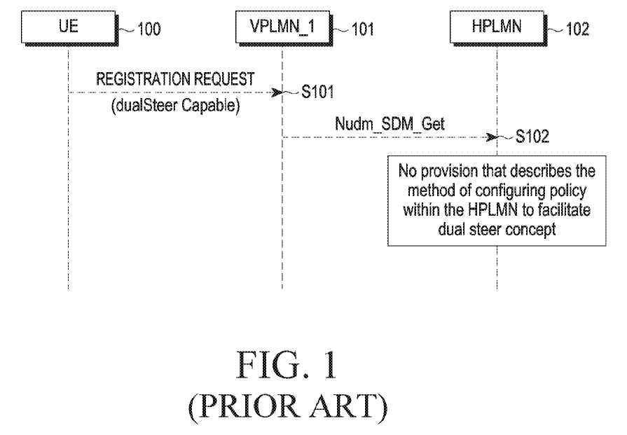

Referring now to the drawings and more particularly to FIGS. 1 through 6, where similar reference characters denote corresponding features consistently throughout the figures, these are shown various example embodiments.

FIG. 1 is a signal flow diagram illustrating a scenario of the UE requesting traffic steering and switching of the user data according to the prior art. At operation S101, a dual steer capable UE (100) registers to a VPLMN network, e.g., VAMF. The VPLMN verifies and authenticates the UE (100) that is attempting to access the network.

At operation S102, the VPLMN (e.g., AMF) sends a signal or SBA message, e.g., Nudm_SDM_Get, to fetch the UE subscription information. The Nudm_SDM_Get operation involves the fetching of the relevant subscription data from the HPLMN. The VPLMN needs to retrieve subscription information like the subscriber's service plan, security settings, and roaming restrictions from the HPLMN. Currently, there is no provision that describes the method of configuring policy from the HPLMN/VPLMN to facilitate dual steering in the UE (100). Since the SBA message is often a key operation in the process of registering a roaming user, delays in retrieving subscription data may lead to longer registration times. This may negatively affect the user experience, especially for subscribers moving between networks frequently or in high-demand roaming areas.

Hence, there is a need to design the dual steering policy, which includes rules and criteria for selecting a second success network for the dual registration and transmission control of user data (for different services) across two 3GPP access networks.

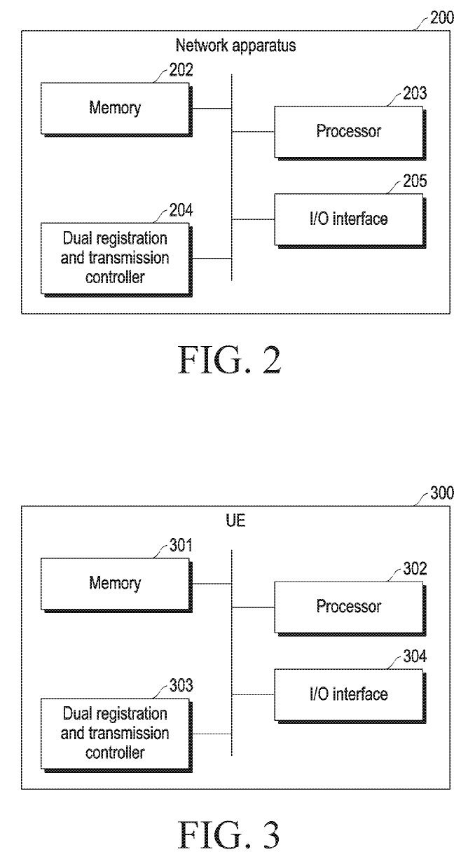

FIG. 2 is a block diagram illustrating an example configuration of the network apparatus (200), according to various example embodiments. In an embodiment, the network apparatus (200) encompasses a diverse range of devices that include but not limited to HPLMN, access and mobility management function (AMF), home unified data management (H-UDM), home policy control function (H-PCF) and others. In an embodiment, the network apparatus (200) includes a memory (202), at least one processor (203), an I/O interface (205), and a dual registration and transmission controller (204). In an embodiment, the dual registration and transmission controller (204) may be included in the processor (203).

The memory (202) stores instructions to be executed by the processor (203). The memory (202) may include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (202) may, in some examples, be considered a non-transitory storage medium. The term non-transitory may indicate that the storage medium is not embodied in a carrier wave or a propagated signal. However, the term non-transitory should not be interpreted to refer, for example, to the memory (202) being non-movable. In some examples, the memory (202) stores larger amounts of information. In certain examples, a non-transitory storage medium may store data that may change over time (e.g., in random access memory (RAM) or cache). The memory (202) stores the list of PLMN-IDs, list of access network types, and the list of RATs. Further, it stores a specified geographical area in which the UE (300) is permitted to register on the second access network and a specified time slot during which the UE (300) is permitted to register on the second access network.

The processor (203) may include various processing circuitry including one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (203) may include multiple cores and is configured to execute the instructions stored in the memory (202). The processor (203) fetches the service plan, security settings, roaming restrictions, and others. Further, the processor (209) retrieves instructions and executes them. Thus, the processor 203 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The I/O interface (205) may include various circuitry and transmits the information between the memory (202) and external peripheral devices. The peripheral devices are the input-output devices associated with the network apparatus (200). The I/O interface (205) receives several pieces of information from a plurality of UEs, network devices, servers, and the like. The I/O interface (205) ensures that the operating speed of the processor is synchronized with respect to the input and output devices. The I/O interface (205) establishes a connection between different peripheral devices like the memory (202), the dual registration and transmission controller (204), and others to perform the dual registration and transmission control in a wireless communication network to enhance the user experience.

In an embodiment, the dual registration and transmission controller (204) may include various circuitry and/or executable program instructions and communicates with the processor (203), I/O interface (205), and memory (202) for managing PLMN selection, dual registration and transmission control in a wireless communication network. The dual registration and transmission controller (204) is configured to generate the dual steering policy for a UE (300), wherein the dual steering policy is dynamically updated based on real-time network performance metrics and user mobility patterns.

The dual steering policy includes a prioritized list of PLMN-IDs on which the UE (300) is permitted to register on the second access network, the prioritized list of access network types including terrestrial networks and NTN, and the prioritized list of radio access technologies (RATs) that the UE (300) is permitted to attempt to register on the second access network. The prioritized list of PLMN-IDs is generated based on example factors such as signal strength, network congestion, and service availability and others. The access network types are categorized based on their coverage areas and latency characteristics, allowing the UE (300) to select the most suitable network for its current location and application requirements. The RATs are selected based on their compatibility with the UE's hardware capabilities and the specific services being accessed by the user. Further, the dual steering policy includes the specified geographical area in which the UE (300) is permitted to attempt to register on the second access network and the specified time slot during which the UE (300) is permitted to attempt to register on the second access network. The geographical area is defined using geofencing technology, which ensures that the UE (300) attempts registration in regions with optimal network conditions. The time slot is identified based on network traffic patterns, allowing the UE (300) to avoid peak usage times and reduce the likelihood of connection failures.

The dual registration and transmission controller (204) transmits the dual steering policy to the UE (300) for the selection of a second access network for dual registration and transmission control. The transmission of the dual steering policy is secured using encryption protocols to prevent/reduce/block unauthorized access and ensure data integrity. The UE (300) receives the policy and utilizes its internal decision-making algorithms to evaluate the available networks against the criteria specified in the policy. Once a suitable network is identified, the UE (300) initiates the registration process, leveraging its multi-band antenna system to establish a stable connection. The dual registration capability allows the UE (300) to maintain simultaneous connections to multiple networks, providing redundancy and enhancing overall communication reliability.

In an embodiment, the dual steering policy are transmitted in a Non-Access Stratum (NAS) message from the network apparatus. The transmission of this dual steering policy to the UE (300) is facilitated through a non-access stratum (NAS) message from the network apparatus (200), ensuring that the policy is delivered securely and efficiently. This approach not only enhances the user experience by providing seamless connectivity but also optimizes network resources by distributing the load across multiple networks and technologies.

FIG. 3 is a block diagram illustrating an example configuration of the UE according to various example embodiments. With reference to FIG. 3, the UE (300) may encompass a diverse range of devices, including but not limited to laptops, palmtops, desktops, mobile phones, smartphones, personal digital assistants (PDAs), tablets, wearable devices, internet of things (IoT) devices, virtual reality devices, foldable devices, flexible devices, display devices, and immersive systems. In an embodiment, the UE (300) includes a memory (301), at least one processor (302), an I/O interface (304), and a dual registration and transmission controller (303). In an embodiment, the dual registration and transmission controller (304) may be included in the processor (302).

The memory (301) stores instructions to be executed by the processor (302). The memory (301) may include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (301) may, in some examples, be considered a non-transitory storage medium. The term non-transitory may indicate that the storage medium is not embodied in a carrier wave or a propagated signal. However, the term non-transitory should not be interpreted that the memory (301) is non-movable. The memory (301) stores the dual steering policy transmitted by the network apparatus (200), the data transmission rules, UE capabilities, and others.

The processor (302) may include various processing circuitry including one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (302) may include multiple cores and is configured to execute the instructions stored in the memory (301). The processor (302) fetches the capability of the UE (300), information regarding the data transmission rules, and the dual steering capabilities of the UE (300). Further, the processor (302) retrieves instructions and executes them. Thus, the processor 302 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The I/O interface (304) may include various circuitry and transmits the information between the memory (301) and external peripheral devices. The peripheral devices are the input-output devices associated with the network apparatus (200). The I/O interface (304) receives several pieces of information from a plurality of UEs, network devices, servers, and the like. The I/O interface (304) ensures that the operating speed of the processor is synchronized with respect to the input and output devices. The I/O interface (304) establishes a connection between different peripheral devices like memory, dual registration and transmission controller (303), and others to perform the dual registration and transmission control in a wireless communication network.

In an embodiment, the dual registration and transmission controller (303) may include various circuitry and/or executable program instructions and communicates with the processor (302), I/O interface (304), and memory (301) for managing dual registration and transmission control in a wireless communication network.

The dual registration and transmission controller (303) is configured to register on the first access network and receive a dual steering policy and the plurality of data transmission rules from the network apparatus (200) while being registered on the first access network. The dual steering policy is used for the selection of the second access network for the dual registration and transmission control. Further, the dual registration and transmission controller (303) selects the second access network for the dual registration and transmission control based on the dual steering policy.

In an embodiment, the dual steering policy includes the prioritized list of PLMN identifiers (PLMN-IDs) on which the UE (300) is permitted to register on the second access network, the prioritized list of access network types including terrestrial networks and NTN. The dual steering policy includes the prioritized list of RATs that the UE (300) is permitted to register on the second access network.

In an embodiment, the UE (300), upon selecting the second access network for the dual registration and transmission control based on the dual steering policy, verifies the dual steering policy configured at the UE (300) includes data transmission rules and performs the data transmission based on the plurality of data transmission rules on the selected second access network.

In an embodiment, the plurality of data transmission rules include the information on whether the UE (300) is allowed to act as a dual steer device, whether the UE (300) is allowed to act as a dual steer device but only for non-simultaneous data transmission, whether the UE (300) is allowed to act as a dual steer device but only for simultaneous data transmission, and whether the UE (300) is allowed to act as a dual steer device for both simultaneous and non-simultaneous data transmission. The UE based on this information in the dual steering policy and the plurality of data transmission rules, identifies whether it may do simultaneous data transmission (if allowed) or not perform simultaneous data transmission (if not allowed).

In an embodiment, the dual steering policy is received in a NAS message from the network apparatus (200).

In an embodiment, the dual registration and transmission controller (303) and the dual registration and transmission controller (204) are an innovative hardware component integrated into the corresponding network apparatus (200) the UE (300) via processing circuitry, which includes logic gates, integrated circuits, microprocessors, microcontrollers, memory circuits, and various electronic and optical components. These circuits may be on semiconductor chips or substrates like printed circuit boards.

At least one component of the dual registration and transmission controller (303) may use an AI/ML model. Functions associated with the AI model are executed through the memory and processor. The processors manage input data processing based on specified operating rules or AI/ML models stored in volatile and non-volatile memory. These models are created through training or learning processes.

Learning involves applying a learning process to multiple data sets to develop a desired operating rule or AI/ML model. This may occur within the device or via a separate server/system. The AI/ML model may include multiple neural network layers, each with weight values and layer operations. Examples of neural networks include CNN, DNN, RNN, RBM, DBN, BRDNN, GAN, and deep Q-networks. The learning process trains a target device (e.g., a robot) using various data to enable it to make decisions or predictions. Learning methods include supervised, unsupervised, semi-supervised, and reinforcement learning.

While FIGS. 2 and 3 illustrate the hardware components of the network apparatus (200) and the UE (300), various example embodiments may include different or additional components. The labels or names of these elements are illustrative and do not limit the disclosure's scope. Components may also be combined to perform similar functions.

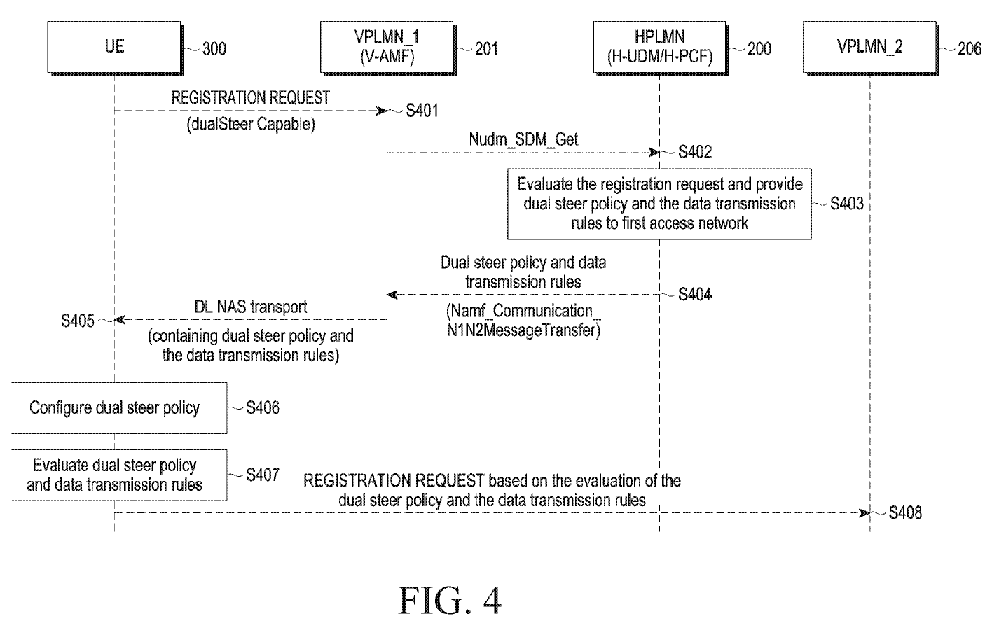

FIG. 4 is a signal flow diagram illustrating example operations of the UE (300) with active dual steer functionality according to various example embodiments. At operation S401, the UE (300) sends a 5GMM message, e.g., REGISTRATION REQUEST/UL NAS TRANSPORT or any other NAS message, and updates its capability of dual steer capable and registers to a VPLMN network, e.g., VPLMN1 (201), over RAT-type as RAT1. The RAT-type identifies the transmission technology used in the access network for 3GPP access described in the example embodiment. RAT types include, but are not limited to, E-UTRA, NR, one of the satellite accesses, e.g., NR(LEO), NR(MEO), NR(GEO), and NR(OTHERSAT).

At operation S402, the VPLMN_1 (201) (for example, AMF) sends a signal or SBA message, for example, Nudm_SDM_Get message, to fetch the UE subscription information. The subscription information is stored and retrieved by the UDM (via the Nudm_SDM_Get message, for example), and it provides details on how the network should handle a UE's services, access rights, and other parameters.

At operation S403, the HPLMN (200) processes the policy request from the VPLMN_1 (201) based on various parameters like subscription, application/traffic type, service preference, QoS requirements, location, time, the UE capabilities, mobility, connectivity conditions, and provides a dual steer policy to UE (300), for example, via VPLMN_1 (201). The dual steer policy could be sent in Namf_Communication_N1N2MessageTransfer service operations or any other service operations as illustrated in operation S404. In this illustration, it is described that when the UE (300), which is dual steer capable, triggers the registration procedure, the dual steer policy is updated in the UE (300), but this may occur at any point in time, for example, during the registration procedure or when UDM/PCF identifies the policies have changed or need to be updated based on at least one of the subscription, application/traffic type, service preference, QoS requirements, location, time, UE capabilities, mobility, connectivity conditions.

In an embodiment, the dual steer policy includes the prioritized list of PLMN identifiers (PLMN-IDs) on which the UE (300) is permitted to register on the second access network. The list of PLMN-IDs identifies the order in which the UE (300) should attempt to connect to available networks. The dual steer policy includes the prioritized list of access network types, including terrestrial networks and NTN, based on a combination of factors related to generated coverage, availability, quality of service (QoS), network configuration, and others. Further, the dual steer policy includes the prioritized list of RAT on which the UE (300) is permitted to register on the second access network and the specified geographical area in which the UE (300) is permitted to register on the second access network. Further, the dual steer policy also includes the specified time slot during which the UE (300) is permitted to register on the second access network. The prioritization helps the UE (300) to choose the best network available, ensuring efficient and reliable connectivity across different network types and conditions.

At operation S405, the VPLMN_1 (201) sends the NAS message, for example, DL NAS TRANSPORT/REGISTRATION ACCEPT message, to the UE (300). The VPLMN_1 (201) includes the dual steer policy received from HPLMN (200) or locally generated in VPLMN_1(201) based on at least one of the local policy operation, local configuration, subscription, application/traffic type, service preference, QoS requirements, location, time, the UE capabilities, mobility, connectivity conditions in the NAS message. The dual steer policy includes rules and criteria for selecting a second network to facilitate traffic steering and switching of user data (for different services) across two 3GPP access network.

At operation S406, the dual steer policy and the data transmission rules are configured at the UE (300). The dual steer policy and the data transmission rules include the information on whether the UE (300) is allowed to act as a dual steer device or whether the UE (300) is allowed to act as a dual steer device but only for non-simultaneous data transmission where all services use the same network connection at a time (no simultaneous data transfer over the two networks) for data communication and may switch between two networks as per traffic switching procedure but does not transmit data over two networks simultaneously. Further, the data transmission rules include the information on whether the UE (300) is allowed to act as a dual steer device but only for simultaneous data transmission where different services are steered across different networks concurrently (with simultaneous data over the two networks) or the UE (300) is allowed to act as a dual steer device for both simultaneous data transmission and non-simultaneous data transmission. The UE (300) may receive a policy from HPLMN (200) which includes the data transmission rules such as the UE (300) is not allowed to act as a dual steer device or the UE (300) is not allowed to act as a dual steer device for non-simultaneous data transmission or the UE (300) is not allowed to act as a dual steer device for simultaneous data transmission or the UE (300) is not allowed to act as a dual steer device for both simultaneous data transmission and non-simultaneous data transmission.

Further the UE (300) evaluates the dual steer policy and the data transmission rules received from the network apparatus (201) and selects the second access network for the dual registration and transmission control based on the dual steering policy and the data transmission rules as illustrated at the operation S407. The UE (300) evaluates the configured dual steer policy and makes decision to select and register itself over the identified second network (for e.g. VPLMN_2 (206)) based on the received policy or configuration in the UE (300). The UE (300) could take at least one of the below actions to evaluate the dual steer policy while registered over VPLMN_1(201),

The UE (300) checks if it is allowed to act as dual steer device over the current access network.

The UE (300) checks if it is allowed only for non-simultaneous data transmission.

The UE (300) checks if it is allowed only for simultaneous data transmission.

The UE (300) checks if it is allowed for both simultaneous and non-simultaneous data transmission.

Based on this evaluation, the UE will decide whether it may act as a dual steer device and it may perform simultaneous data transmission or non-simultaneous data transmission or both.

The UE (300) may be configured with a policy of allowed VPLMNs, RAT, and access type combinations. For example, when the UE (300) is registered on HPLMN/VPLMN_1, it may register on any other VPLMN or RAT. When the UE (300) is registered on HPLMN/VPLMN_1, it may register on VPLMN_2, VPLMN_3, or others (optionally in priority order). In this case, if the configured VPLMNs are not available, e.g., VPLMN_2, VPLMN_3, the UE (300) may select an available VPLMN in random order. Further, in an embodiment, the UE (300) may be configured not to select any other VPLMN and shall not apply a dual steering policy if the configured VPLMNs are not available based on the requirement. When the UE (300) is registered on VPLMN_1 (201), it may register on RAT-1, RAT-2 of at least one of VPLMN_1 (201) and VPLMN_2 (206) (optionally in priority order), e.g., PLMN + RAT combination. When the UE (300) is registered on VPLMN_1 (201), it may register on Access type-1, Access type-2 of at least one of VPLMN_1 (201) and VPLMN_2 (206) (optionally in priority order), e.g., PLMN + access type (3GPP access or non-3GPP access) combination.

For all above configurations, further, each of the HPLMN, VPLMN_1, VPLMN_2, etc., the VPLMN_2, VPLMN_3 may not support dual steering in all the areas; thus, the UE (300) may be configured exactly in which areas the UE (300) may act or behave or is allowed to act as a dual steer device. For example, TAI(s), Cell(s), CAG-ID(s), geographical area and others. The VPLMN_2, VPLMN_3 may not support dual steering for all the time; thus, the UE (300) may be configured exactly in which time slot (start time and end time) the UE (300) may act as a dual steer device. For example, between 2 to 5 PM or at 2 O'clock for 60 minutes, which may be further based on the particular day, etc. For example, on every Monday between 2 to 5 or on 21st July between 2 to 5, etc. In an embodiment, the given VPLMN may be selected or not selected based on a combination of allowed location and allowed time. If time or the geographical location are not allowed the respective entry of the VPLMN or VPLMN+RAT combination or VPLMN + access type combination or VPLMN + RAT + Access type combination is not a candidate for PLMN selection or RATselection or access type selection or cell selection/reselection.

The VPLMN_1 (201) is used for illustration purposes in this example; it may be HPLMN or SNPN or PNI-NPN. Similarly, VPLMN_2 (200) is used for illustration purposes in this embodiment; it may be any of the HPLMN or SNPN or PNI-NPN, etc.

For each of the above actions taken by the UE (300) to evaluate the dual steer policy while registered over VPLMN_1 (201), the UE (300) evaluates the VPLMN/RAT combination and considers the below possible case to select a second access network. Considering the above-mentioned illustration, when the UE (300) is registered on HPLMN/VPLMN-1 and if it may register on any other VPLMN or RAT, the UE (300) considers no specific restriction on choosing VPLMN or RAT over which the UE (300) could register for second access.

The UE (300) considers any VPLMN or RAT combination as a potential choice for second access network for dual steering. Considering the second case of the illustration, e.g., when the UE (300) is registered on HPLMN/VPLMN_1, the UE (300) may register on VPLMN_2, VPLMN_3 (optionally in priority order), and if the configured VPLMNs are not available, the UE (300) may select an available VPLMN in random order. The UE (300) considers the priority order for VPLMNs provided in the dual steer policy to choose the second access network for dual steering. Furthermore, when the UE (300) is registered on VPLMN_1, the UE (300) may register on RAT-1, RAT-2 of at least one of VPLMN_1 and VPLMN_2. The UE (300) considers the priority order for RATs of the second access network to choose the second access network for dual steering. The second access network could be any VPLMN, including VPLMN_1 (300), over which it is currently registered. When the UE (300) is registered on VPLMN_1, the UE (300) may register on Access type-1, Access type-2 of at least one of VPLMN-1 and VPLMN-2 (optionally in priority order), e.g., PLMN + access type (3GPP access or non-3GPP access) combination. The UE (300) considers the priority order for access types (Access type-1 or Access type-2) of the second access network to choose the second access network for dual steering and chooses a PLMN + Access type combination. The second access network could be any VPLMN, including VPLMN_1, over which it is currently registered.

While evaluating the dual steer policy while registered over VPLMN_1 (201), the UE (300) continues with its current registration on VPLMN_1 and doesn't initiate any action for selecting a second network and continues to monitor for any changes in the received policy and decides when the UE (300) could act as a dual steer device and select a second network.

At operation S408, based on the evaluated dual steer policy, if UE (300) is allowed to perform dual steering, the UE (300) selects the respective second access network e.g., at least one of the PLMN, RAT and access type and transmits the registration request to the selected second access network requesting the dual steer registration and transmission and to facilitate traffic steering and switching of the user data. The registration request from the UE (300) to the second access network, e.g., VPLMN_2 (206) in the illustration, is part of the process by which the UE (300) registers itself on the second access network. The registration request includes, but is not limited to, the UE (300) identity like international mobile subscriber identity (IMSI), temporary mobile subscriber identity (TMSI), the location area information, the access technology, the requested registration type, the subscriber profile, the PLMN ID, and others. The second access network (e.g., VPLMN_2 (206)) accepts the registration request, and the UE (300) has an active connection with both the initial VPLMN (VPLMN_1 (201)) and the second access network (VPLMN_2 (206)), enabling the dual steer functionality. The UE (300) would monitor for any changes in the dual steer policy and could take further actions with respect to the modified/updated dual steer policy.

Upon initial registration over VPLMN_1 (201) using RAT1, the UE (300) may dynamically select a second access network based on the criteria provided in the dual steer policy by the HPLMN (200). The UE (300) considers factors like:

Service Type - Consider the type of service being utilized (e.g., voice, video, data) to optimize the selection of the second network.

QoS Requirements: Evaluate quality of service (QoS) requirements for the specific service to ensure an enhanced user experience

Location-Based Optimization: Network selection based on the UE's geographical location, considering factors such as camped MCC, cell, TAI, LAI, longitude, latitude.

Time-of-Day Consideration: Implement time-based policies, adapting the network selection based on the time of day to meet varying traffic patterns and demands.

UE Capabilities: Consider the capabilities of the UE, including support for rat-type when selecting the second network. The rat-type identifies the transmission technology used in the access network for 3GPP access.

By incorporating these criteria into the rule, the UE (300) gains the ability to make informed and dynamic decisions when selecting the second network within VPLMN_1 (201). This approach enhances the adaptability and responsiveness of the dual steer concept, catering to diverse user needs and network conditions.

The UE (300) selects and attempts registration on any PLMN/access technology combinations, if available and allowable, in the configured priority order as shown below:

either the registered public land mobile network (RPLMN) or the Last registered PLMN;

either the HPLMN (if the EHPLMN list is not present or is empty) or the highest priority equivalent home public land mobile network(EHPLMN) that is available (if the EHPLMN list is present);

each PLMN/access technology combination in the "User Controlled PLMN Selector with Access Technology" data file in the SIM (in priority order);

each PLMN/access technology combination in the "Operator Controlled PLMN Selector with Access Technology" data file in the SIM (in priority order) or stored in the ME (in priority order);

other PLMN/access technology combinations with received high quality signal in random order;

other PLMN/access technology combinations in order of decreasing signal quality.

### Forbidden PLMNs

The UE (300) ignores the first selected entry and selects the second access network combination from the same list. The second access network may be VPLMN-2 RAT-2 or access type and the like. In general, the UE (300) is configured with a list of access network(s) (e.g., PLMN+RAT combination), which may be in the same list or two different lists (the first list is to select the first access network, and the second list is to select the second access network optionally in priority order). The UE (300) selects the first access network and (optionally after registering with the first access network) selects the second access network by ignoring the first access network selected by the UE (300).

In an embodiment, the UE (300) may receive a policy from the network apparatus (200) which includes the below rules:

Not allowed to act as dual steer device.

Not allowed to act as dual steer device for non-simultaneous data transmission.

Not allowed to act as dual steer device for simultaneous data transmission.

Not allowed to act as dual steer device for both simultaneous data transmission and non-simultaneous data transmission.

In an embodiment, the dual steering policy addresses various factors, including network diversity, which encompasses RAT type, frequency bands, and geographical coverage. Parameters such as user subscription, location, time, QoS requirements, and UE capabilities are considered to add granularity and fine-tune the decision-making process at the UE (300). This process enables the steering or switching of user data for different services across two 3GPP access networks. The dual steering policy enable real-time decision-making at the UE (300), allowing it to dynamically assess networks and switch between them, or utilize dual steering capabilities.

When the UE (300) acts as a dual steer device, the UE (300) uses SUPI-1 (primary) for registering with the first network. Based on the determination that it may act as a dual steer device and selecting the second network based on the dual steering policy, the UE (300) will use SUPI-2 (secondary) to register with the second network (second access network); otherwise, SUPI-2 should not be used. The Subscription Permanent Identifiers (SUPI) SUPI-1 and SUPI-2 are used as an example in this embodiment, this may be any other identifier which will differentiate the two accesses made to the network.

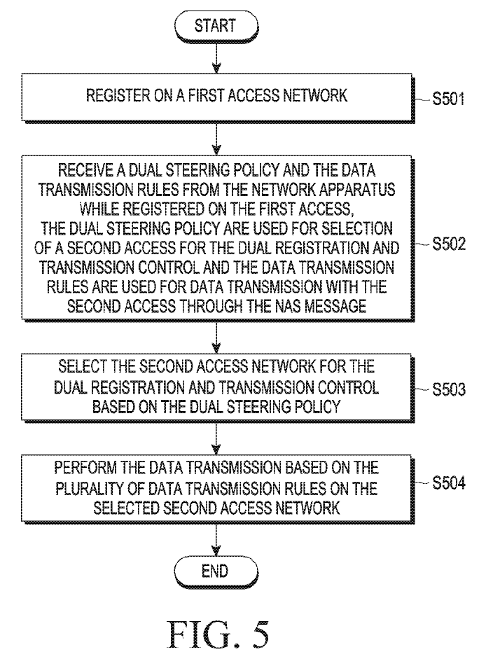

FIG. 5 is a flowchart illustrating an example method of dual registration and transmission control in a wireless communication network according to various example embodiments. At operation S501, the UE (300) registers on the first access network.

At operation S502, the UE (300) receives a dual steering policy and the data transmission rules from the network apparatus (200) while registered on the first access, the dual steering policy are used for selection of a second access for the dual registration and transmission control and the data transmission rules are used for data transmission with the second access through the NAS message.

At operation S503, the UE (300) selects the second access network for the dual registration and transmission control based on the dual steering policy. the dual steering policy includes the prioritized list of the PLMN-IDs, the prioritized list of access network types, including terrestrial networks and NTN, prioritized list of RATs, the specified geographical area and the specified time slot during which the UE (300) is allowed to register on the second access. The UE (300) evaluates each criteria provided in the dual steering policy to select the second access network.

The UE (300) considers the data transmission rules provided along with the dual steering policy from the network apparatus (200) to decide whether the UE (300) is allowed to act as a dual steer device for simultaneous data transmission or to act as a dual steer device for non-simultaneous data transmission, or the UE (300) is allowed to act as a dual steer for both simultaneous and non-simultaneous data transmission.

In an embodiment, the data transmission rules include the information on whether the UE (300) is allowed to act as dual steer device or is allowed to act as a dual steer device but only for non-simultaneous data transmission. Further the UE (300) may be allowed to act as dual steer device but only for simultaneous data transmission or is allowed to act as dual steer device for both simultaneous and non-simultaneous data transmission.

At operation S503, the UE (300) selects the second access network for the dual registration and transmission control based on the dual steering policy. Further the UE (300) performs the data transmission based on the plurality of data transmission rules on the selected second access network as illustrated in the operation S504.

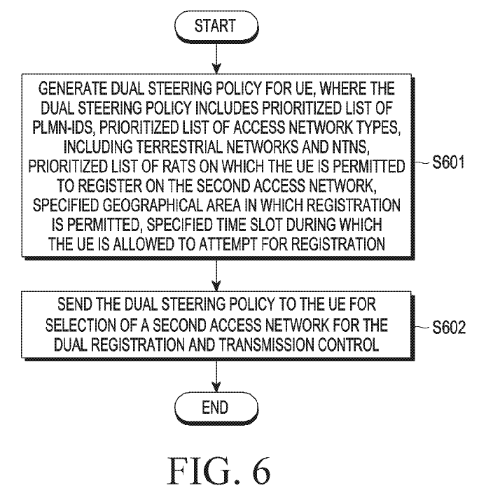

FIG. 6 is a flowchart illustrating an example method of dual registration and transmission control in a wireless communication network according to various example embodiments.

At operation S601, the network apparatus (200) generates the dual steering policy. The dual steering policy includes prioritized list of PLMN-IDs, the prioritized list of the access network types, including terrestrial networks and NTN on which the UE (300) and the prioritized list of RATs on which the UE (300) is permitted to register on the second access network. Further the dual steering policy include the specified geographical area in which registration is permitted and the specified time slot in which the UE (300) is permitted to register on the second access network.

At operation S602, the network apparatus (200), transmits the generated dual steering policy to the UE (300) for selection of a second access network for the dual registration and transmission control. In an embodiment, the dual steering policy is transmitted in a NAS message by the network apparatus (200) to the UE (300).

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended

claims and their equivalents. It will also be understood that any of the embodiment(s) described herein may be used in conjunction with any other embodiment(s) described herein.

What is claimed is:

1. A method for controlling dual registration and transmission in a wireless communication network, comprising:
registering, by a user equipment (UE), on a first access network;
receiving, by the UE, a dual steering policy from a network apparatus while registered on the first access network; and
selecting, by the UE, a second access network for the dual registration and transmission based on the dual steering policy,
wherein the dual steering policy includes at least one of:
a prioritized list of public land mobile network identifier (PLMN-ID) on which the UE is permitted to register on the second access network,
a prioritized list of access network types,
a prioritized list of radio access technologies (RATs) on which the UE is permitted to register on the second access network,
an area in which the UE is permitted to register on the second access network, and/or
time information during which the UE is permitted to register on the second access network.

2. The method of claim 1, wherein the access network types includes terrestrial network (TN) access and non-terrestrial network (NTN) access, and wherein the time information includes at least one of time start, time stop, and/or a day of week.

3. The method of claim 1, wherein the UE receives the dual steering policy with a plurality of data transmission rules, and
wherein the plurality of data transmission rules comprises at least one of: whether the UE is allowed to act as dual steer device, whether the UE is allowed to act as dual steer device but only for non-simultaneous data transmission, whether the UE is allowed to act as dual steer device but only for simultaneous data transmission and whether the UE is allowed to act as dual steer device for both simultaneous and non-simultaneous data transmission.

4. The method of claim 1, wherein the dual steering policy is received in a non-access stratum (NAS) message from the network apparatus.

5. A user equipment (UE) for dual registration and transmission control in a wireless communication network, comprises:
at least one processor comprising processing circuitry; and
memory storing instructions, wherein the instructions, when executed by at least one processor, individually and/or collectively, cause the UE to:
register on a first access network;
receive a dual steering policy from a network apparatus while being registered on the first access network, wherein the dual steering policy is used for selection of a second access network; and
select the second access network for the dual registration and transmission based on the dual steering policy,
wherein the dual steering policy contains at least one of:
a prioritized list of public land mobile network identifier (PLMN-ID) on which the UE is permitted to register on the second access network,
a prioritized list of access network types,
a prioritized list of radio access technologies (RATs) on which the UE is permitted to register on the second access network,
an area in which the UE is permitted to register on the second access network, and/or
time information during which the UE is permitted to register on the second access network.

6. The UE (300) of claim 5, wherein the access network types includes terrestrial network (TN) access and non-terrestrial network (NTN) access, and wherein the time information includes at least one of time start, time stop, and/or a day of week.

7. The UE of claim 5, wherein the instructions, when executed by at least one processor, individually and/or collectively, cause the UE to receive the dual steering policy with a plurality of data transmission rules, and
wherein the plurality of data transmission rules comprises at least one of: whether the UE is allowed to act as dual steer device, whether the UE is allowed to act as dual steer device but only for non-simultaneous data transmission, whether the UE is allowed to act as dual steer device but only for simultaneous data transmission and whether the UE is allowed to act as dual steer device for both simultaneous and non-simultaneous data transmission.

8. The UE of claim 5, wherein the dual steering policy is received in a non-access stratum (NAS) message from the network apparatus.

9. One or more non-transitory computer-readable storage media storing one or more computer programs including computer-executable instructions that, when executed by at least one processor of a user equipment (UE) individually or collectively, the UEe comprising communication circuitry, the executed instructions cause the UE to perform operations, the operations comprising:
registering on a first access network;
receiving a dual steering policy from a network apparatus while registered on the first access network; and
selecting a second access network for the dual registration and transmission based on the dual steering policy,
wherein the dual steering policy includes at least one of:
a prioritized list of public land mobile network identifier (PLMN-ID) on which the UE is permitted to register on the second access network,
a prioritized list of access network types,
a prioritized list of radio access technologies (RATs) on which the UE is permitted to register on the second access network,
an area in which the UE is permitted to register on the second access network, and/or
time information during which the UE is permitted to register on the second access network.

10. The one or more non-transitory computer-readable storage media of claim 9, wherein the access network types includes terrestrial network (TN) access and non-terrestrial network (NTN) access, and wherein the time information includes at least one of time start, time stop, and/or a day of week.

11. The one or more non-transitory computer-readable storage media of claim 9, wherein the UE receives the dual steering policy with a plurality of data transmission rules, and
wherein the plurality of data transmission rules comprises at least one of: whether the UE is allowed to act as dual steer device, whether the UE is allowed to act as dual steer device but only for non-simultaneous data transmission, whether the UE is allowed to act as dual steer device but only for simultaneous data transmission and whether the UE is allowed to act as dual steer device for both simultaneous and non-simultaneous data transmission.

12. The one or more non-transitory computer-readable storage media of claim 9, wherein the dual steering policy is received in a non-access stratum (NAS) message from the network apparatus.
